(19) United States
(12) Patent Application Publication
(10) Pub. No.: US 2022/0305627 A1
(43) Pub. Date: Sep. 29, 2022

(54) INNER C-SHAPED RETAINING RING ASSEMBLY

(71) Applicant: Chun-Sheng KU, Taichung City (TW)

(72) Inventor: Chun-Sheng KU, Taichung City (TW)

(21) Appl. No.: 17/701,410

(22) Filed: Mar. 22, 2022

(30) Foreign Application Priority Data
Mar. 24, 2021 (TW) 110110661

(51) Int. Cl. B25B 23/00; B25B 13/06

(52) U.S. Cl. CPC B25B 23/0028; B25B 13/06

(57) ABSTRACT

An inner C-shaped retaining ring assembly includes a base member having an inner peripheral surface that defines a receiving space and an annular retaining groove, and an outer peripheral surface having at least one aperture communicating with the retaining groove. An insert member has at least a portion received in the receiving space. A C-shaped retaining ring is elastically disposed in the retaining groove to prevent removal of the insert member from the receiving space, and is configured to be acted upon by an external force through the aperture to elastically deform toward the receiving space and form an insertion gap with the inner peripheral surface.

### CROSS-REFERENCE TO RELATED APPLICATION

This application claims priority to Taiwanese Patent Application No. 110110661, filed on Mar. 24, 2021.

### FIELD

The disclosure relates to a tool, more particularly to an inner C-shaped retaining ring assembly.

### BACKGROUND

Referring to FIGS. 1 and 2, an existing universal connector 9 includes a base member 91, an insert member 92, a spring 94 and a C-shaped retaining ring 93. The base member 91 has a receiving space 911 and a drive hole 912 opposite to each other, and an annular retaining groove 915 adjacent to a top end thereof and communicating with the receiving space 911. An inner peripheral surface of the base member 91 defining the receiving space 911 is formed with four ribs 913 and four recesses 914 that are alternately arranged and that extend axially.

The insert member 92 is movably connected to the base member 91 and is adjustable to different angles relative to the same for transmission of torque. The insert member 92 includes a socket portion 921, and a ball-shaped head portion 922 opposite to the socket portion 921 and movably received in the receiving space 911. The ball-shaped head portion 922 has four angularly spaced-apart ear strips 923, and four concave surfaces 924 each formed between two adjacent ones of the ear strips 923. The ear strips 923 are respectively received in and abut against the recesses 914.

The spring 94 is disposed between the ball-shaped head portion 922 and the base member 91 for biasing the ball-shaped head portion 922 to move outwardly. The C-shaped retaining ring 93 is disposed in the annular retaining groove 915 and partially protrudes therefrom for blocking the ear strips 923, so that the insert member 92 remains connected to the base member 91 and cannot be removed therefrom. Torque can be transmitted through engagement of the ear strips 923 of the insert member 92 and the recesses 914 of the base member 9.

Although the existing universal connector 9 can achieve its intended purpose, when the insert member 92 thereof is worn out after being used for a period of time and must be repaired or replaced with a new one, it is difficult to remove the C-shaped retaining ring 93 from the annular retaining groove 915, so that it is also difficult to remove the insert member 92 from the base member 91.

### SUMMARY

Therefore, an object of the present disclosure is to provide an inner C-shaped retaining ring assembly that can alleviate at least one of the drawbacks of the prior art.

According to this disclosure, an inner C-shaped retaining ring assembly includes a base member, an insert member and a C-shaped retaining ring. The base member includes an inner peripheral surface and an outer peripheral surface opposite to each other. The inner peripheral surface defines a receiving space having a top opening, and has an annular retaining groove communicating with the receiving space. The outer peripheral surface has at least one aperture extending through the inner peripheral surface and communicating with the annular retaining groove.

The insert member is movably connected to the base member, and has at least a portion received in the receiving space. The C-shaped retaining ring is elastically disposed in the annular retaining groove to prevent removal of the insert member from the receiving space, and has two free ends, and a gap between the free ends. The C-shaped retaining ring blocks at least a portion of the at least one aperture. The gap does not overlap the aperture. The C-shaped retaining ring is configured to be acted upon by an external force through the at least one aperture to elastically deform toward the receiving space and form an insertion gap with the inner peripheral surface of the base member. The insertion gap is configured for insertion of a tool to facilitate removal of the C-shaped retaining ring from the annular retaining groove.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of an existing universal connector;

FIG. 2 is a sectional view of the existing universal connector;

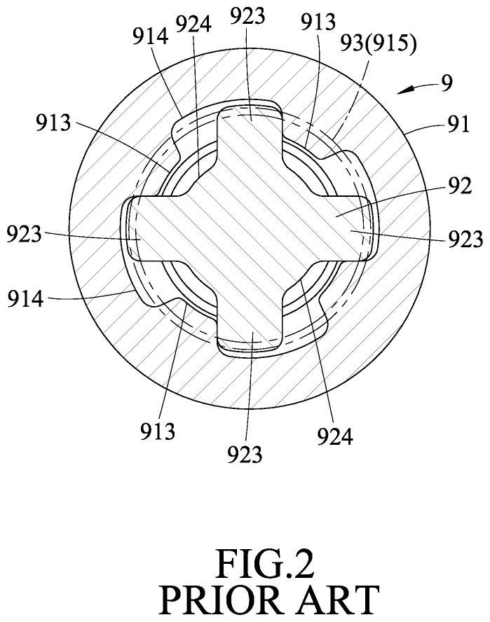

FIG. 3 is a perspective view of an inner C-shaped retaining ring assembly according to an embodiment of the present disclosure;

FIG. 4 is a sectional view of the embodiment;

FIG. 5 is an exploded perspective view of the embodiment;

FIG. 6 is a flow diagram, illustrating the steps involved in a method for dismantling the inner C-shaped retaining ring assembly of the embodiment;

FIG. 7 is a perspective view, illustrating how a first rod of a first tool is inserted into an aperture of a base member of the embodiment;

FIG. 8 is a sectional view, illustrating how the first rod of the first tool is inserted into the aperture of the base member of the embodiment;

FIG. 9 illustrates how the first rod of the first tool extends through the aperture of the base member to push and deform a C-shaped retaining ring;

FIG. 10 illustrates how an insertion end portion of a second tool is inserted into an insertion gap between the C-shaped retaining ring and an inner peripheral surface of the base member through a top opening of the base member;

FIG. 11 illustrates the C-shaped retaining ring being removed from the base member; and

FIG. 12 illustrates an alternative form of an insert member of the embodiment.

### DETAILED DESCRIPTION

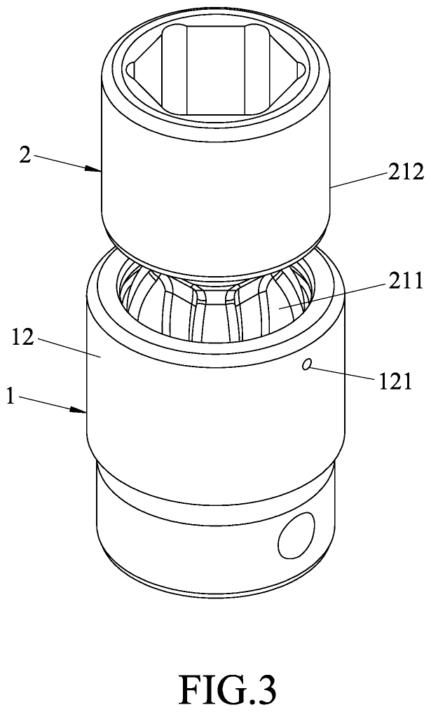

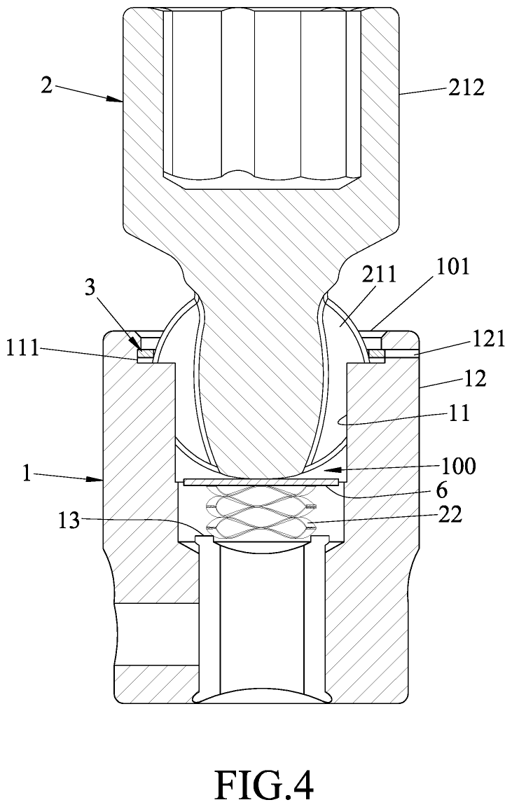

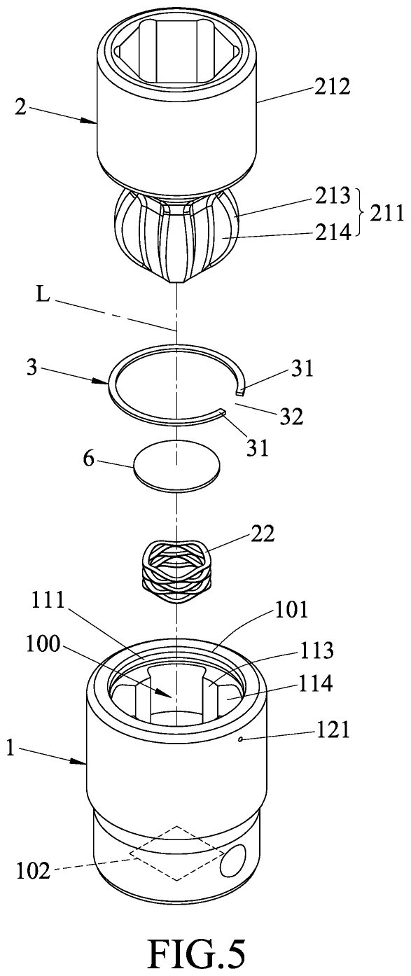

Referring to FIGS. 3 to 5, an inner C-shaped retaining ring assembly according to an embodiment of the present disclosure is exemplified as a universal connector, and includes a base member 1, an insert member 2, an elastic member 22, and a C-shaped retaining ring 3. In other embodiments, the inner C-shaped retaining ring assembly may be a gas check valve or a tool head assembly including a sleeve and a movable rod, but is not limited thereto.

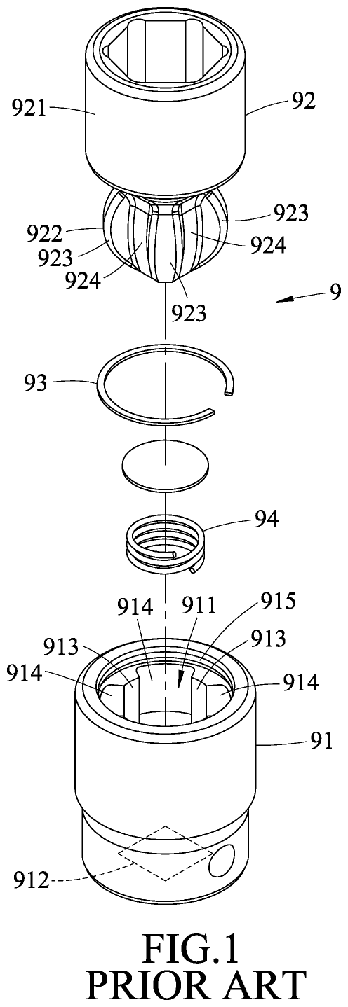

The base member 1 is substantially similar to the base member 91 of the existing universal connector 9 (see FIG. 1). Particularly, the base member 1 has a cylindrical shape defining an axis (L), a receiving space 100 defined by an inner peripheral surface 11 thereof, a drive hole 102 opposite to receiving space 100, and an annular retaining groove 111 communicating with the receiving space 100. The base member 1 includes an inner peripheral surface 11 and an outer peripheral surface 12 opposite to each other in a radial direction. The receiving space 100 is defined by the inner peripheral surface 11, and has a top opening 101 located at a top end of the base member 1. The annular retaining groove 111 extends inwardly from the inner peripheral surface 11 at a position adjacent to the top end of the base member 1. The inner peripheral surface 11 is formed with four ribs 113 and four recesses 114 that are alternately arranged and that extend axially. However, in this embodiment, the outer peripheral surface 12 of the base member 1 has at least one aperture 121 extending through the inner peripheral surface 11 and communicating with the annular retaining groove 111, a spring support 13 is disposed in a lower portion of the receiving space 100, and an auxiliary plate 6 is disposed in the receiving space 100 and is located above and spaced apart from the spring support 13.

It should be understood that the base member 1 is not limited to the cylindrical shape, as long as it is formed with the receiving space 100 and the top opening 101, any shape thereof is acceptable. In this embodiment, the number of the aperture 121 is one. However, in other embodiment, the number of the aperture 121 may be two or more, and the aperture 121 may be a threaded hole having an internal thread. Preferably, the base member 1 is hardened by heat treatment, and is formed with the aperture 121 before the heat treatment.

The insert member 2 is substantially similar to the insert member 92 of the existing universal connector 9 (see FIG. 1). Particularly, the insert member 2 is movably connected to the base member 1 and is adjustable to different angles relative to the same. The insert member 2 includes a ball-shaped head portion 211 movably received in the receiving space 100, and a socket portion 212 extending upwardly from the head portion 211 for connection with a tool head (not shown). The head portion 211 has four angularly spaced-apart ear strips 213, and four concave surfaces 214 each formed between two adjacent ones of the ear strips 213. The ear strips 213 are respectively received in and abut against the recesses 114. In this embodiment, the head portion 211 abuts against the auxiliary plate 6.

The elastic member 22 is disposed between the spring support 13 and the auxiliary plate 6 for biasing the head portion 211 of the insert member 2 to move outwardly. In this embodiment, the elastic member 22 is a multi-wave compression spring.

The C-shaped retaining ring 3 is elastically disposed in the annular retaining groove 111 and partially protrudes therefrom for blocking the head portion 211 of the insert member 2, thereby preventing removal of the insert member 2 from the receiving space 100. The C-shaped retaining ring 3 has two free ends 31, and a gap 32 between the free ends 31. The C-shaped retaining ring 3 blocks at least a portion of the aperture 121. In this embodiment, the C-shaped retaining ring 3 completely blocks the aperture 121, and the gap 32 is adjacent to but not overlapping the aperture 121. That is, the gap 32 and the aperture 121 do not overlap in space. It should be noted herein that the free ends 31 of the C-shaped retaining ring 3 of this embodiment do not have holes, but in other embodiment, the free ends 31 of the C-shaped retaining ring 3 may be respectively provided with holes or notches.

In this embodiment, the base member 1 is used for connection with a power source, such as a pneumatic source or an electric device, while the socket portion 212 of the insert member 2 is used for receiving a tool, such as a sleeve, a screwdriver or an adapter. With the insert member 2 being movably connected to the base member 1 such that it can be moved to a desired angle relative to the base member 1, torque of the power source can be transmitted to the tool.

When the insert member 2 is worn and needs to be repaired or replaced with a new one, the repair or replacement of the insert member 2 can be done by dismantling the inner C-shaped retaining ring assembly using a method of the present disclosure.

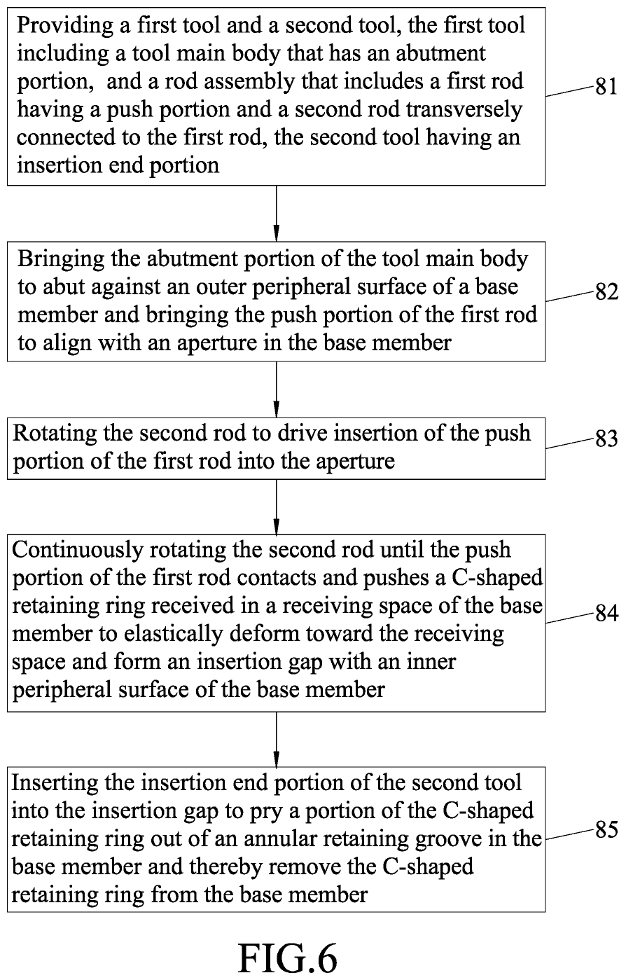

Referring to FIG. 6, in combination with FIGS. 3 to 5 and 7 to 11, the method of dismantling the inner C-shaped retaining ring assembly according to this disclosure includes steps 81 to 85.

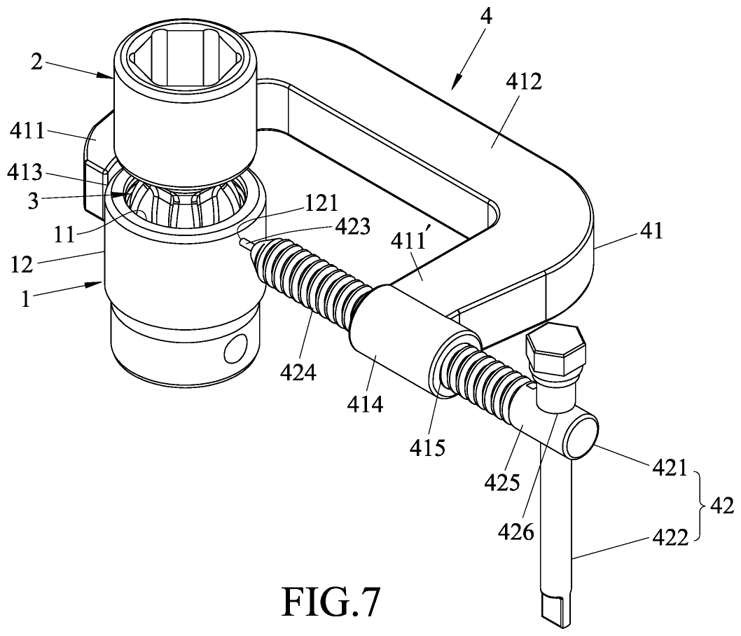

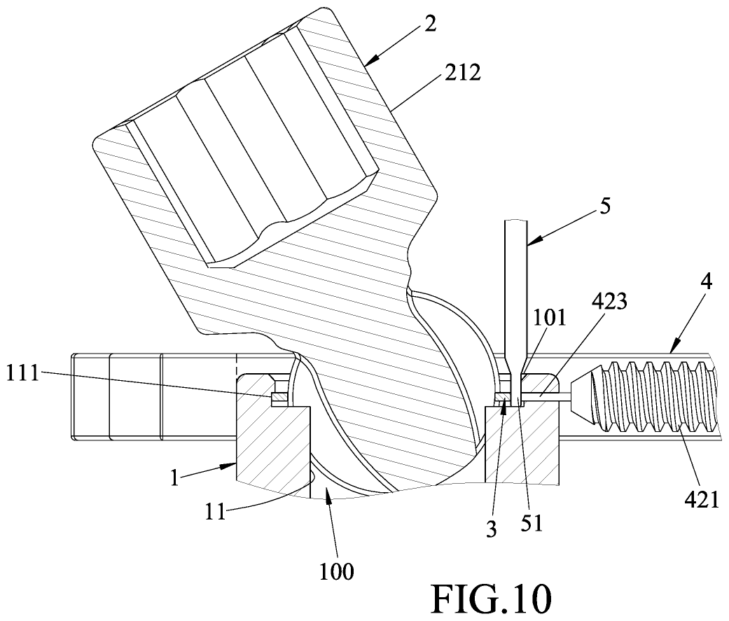

In step 81, with reference to FIG. 7, a first tool 4 and a second tool 5 (see FIG. 10) are provided. The first tool 4 includes a tool main body 41, and a rod assembly 42 rotatably mounted on the tool main body 41. The tool main body 41 is C-shaped, and includes two spaced-apart support arms 411, 411′, and a central arm 412 between the support arms 411, 411′. The support arm 411 has an abutment portion 413 for abutting against the base member 1. The support arm 411′ has a tubular stud 414 provided opposite to the central arm 412 and formed with an internally threaded hole 415.

The rod assembly 42 includes a first rod 421 and a second rod 422. The first rod 421 has an external thread portion 424 threadedly connected to the internally threaded hole 415 of the tubular stud 414, a push portion 423 extending from one end of the external thread portion 424 toward the abutment portion 413 of the support arm 411, and a rear end portion 425 extending rearwardly from the other end of the external thread portion 424 and formed with a through hole 426. The push portion 423 has a needle shape with an outer diameter not greater than an inner diameter of the aperture 121 in the base member 1. The second rod 422 is inserted through the through hole 426 in the rear end portion 425 of the first rod 421 so as to be in perpendicular orientation with the first rod 421.

The second tool 5 of this embodiment is a flat head screwdriver having an insertion end portion 51.

In step 82, the abutment portion 413 of the tool main body 41 is brought to abut against the outer peripheral surface 12 of the base member 1, and the push portion 423 of the first rod 421 is brought to align with the aperture 121.

In step 83, the second rod 422 is rotated to drive the first rod 421 to rotate and move relative to the tubular stud 414 so as to insert the push portion 423 into the aperture 121 toward the C-shaped retaining ring 3.

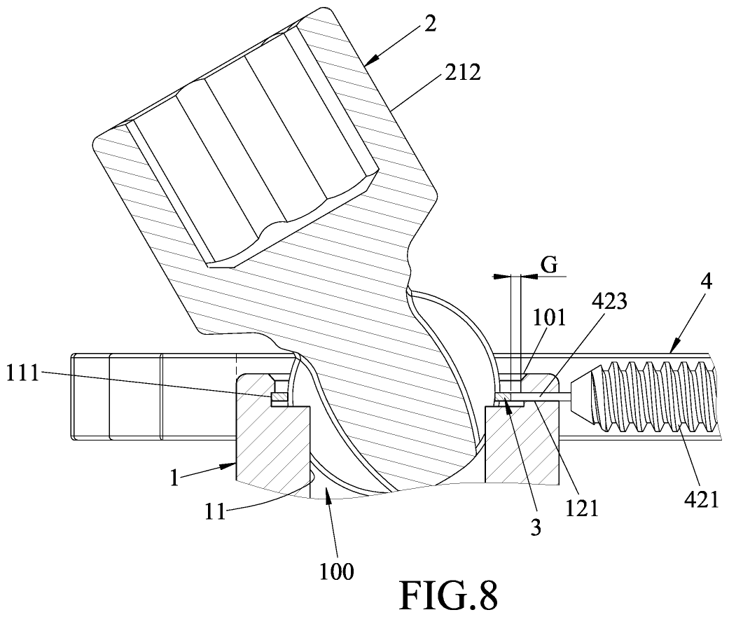

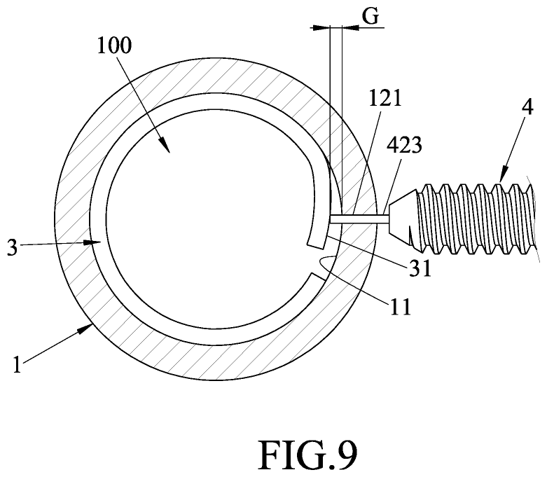

In step 84, with reference to FIGS. 8 and 9, the insert member 2 is moved sideward relative to the base member 1, and the second rod 422 is continuously rotated until the push portion 423 contacts and pushes one of the free ends 31 of the C-shaped retaining ring 3 to elastically deform toward the receiving space 100 and form an insertion gap (G) with the inner peripheral surface 11 of the base member 1.

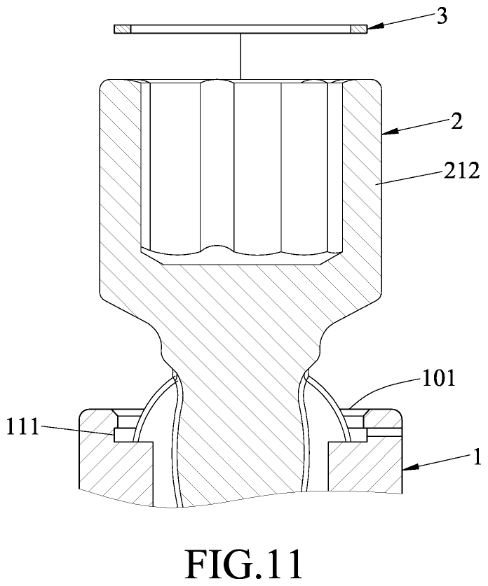

In step 85, with reference to FIGS. 10 and 11, the insertion end portion 51 of the second tool 5 is inserted into the insertion gap (G) (see FIG. 8) through the top opening 101 of the base member 1 to pry out a portion of the C-shaped retaining ring 3. Afterwards, a top portion of the second tool 5 is pulled sideward so that the insertion end portion 51 can push the C-shaped retaining ring 3 to move upward and away from the annular retaining groove 111, and the C-shaped retaining ring 3 can then be removed from the base member 1.

With the removal of the C-shaped retaining ring 3 from the base member 1, the head portion 211 of the insert member 2 can then be pulled out from the receiving space 100 to facilitate repair or replacement of the insert member 2.

In the dismantling method of this disclosure, the push portion 423 of the first tool 4 is inserted into the aperture 121 to act upon the C-shaped retaining ring 3, so that the C-shaped retaining ring 3 is elastically deformed toward the receiving space 100, and the insertion gap (G) is formed between the C-shaped retaining ring 3 and the inner peripheral surface 11 of the base member 1 to facilitate insertion of the insertion end portion 51 of the second tool 5 into the insertion gap (G). The C-shaped retaining ring 3 can be pried out of the annular retaining groove 111 by the insertion end portion 51 of the second tool 5, and can then be removed from the base member 1. Further, in the dismantling method of this disclosure, there is no need to destroy the base member 1, the insert member 2 or the C-shaped retaining ring 3, so that the dismantling method of this disclosure is simple and easy to operate.

It should be noted herein that the outer peripheral surface 12 of the base member 1 may have a plurality of the apertures 121, so that it is convenient to assemble the C-shaped retaining ring 3 into the annular retaining groove 111 without the need for precise alignment. Further, the first tool 4 may be a thin metal rod or an elongated rod, as long as it can be inserted into the aperture 121 and can push the C-shaped retaining ring 3 to form the insertion gap (G) with the inner peripheral surface 11 of the base member 1. The inner C-shaped retaining ring assembly of this disclosure is exemplified as a universal connector having a small volume. Hence, when removing the C-shaped retaining ring 3, the second tool 5 may be a flat head screwdriver, a flat needle, a crochet needle or a flat drill, which can be inserted into the insertion gap (G) and which has a sufficient pulling force to push or pull the C-shaped retaining ring 3. However, in other implementation, the inner C-shaped retaining ring assembly of this disclosure may be, such as but not limited to, a piston device or a cylinder device having a large volume. In this case, the second tool 5 may be a chisel, a plier, a nail puller or other tools with great pulling force.

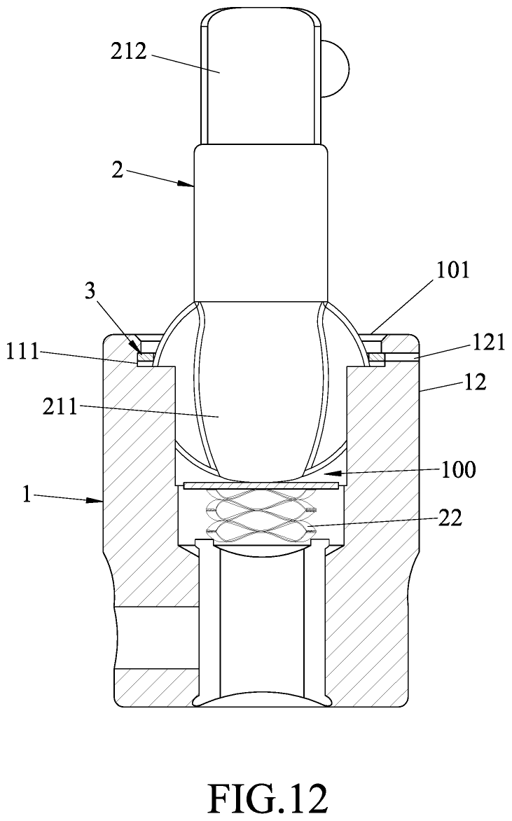

FIG. 12 illustrates an alternative form of the insert member 2. In this case, the socket portion 212 of the insert member 2 is a D-shaped head, and can be used to connect with a sleeve or other similar tools. The type, size and shape of the insert member 2 are not limited to the disclosed embodiment.

In summary, the base member 1 of the inner C-shaped retaining ring assembly of this disclosure is formed with the aperture 121 communicating with the annular retaining groove 111. The aperture 121 can allow insertion of the push portion 423 of the first tool 4 therethrough to push and deform the C-shaped retaining ring 3, so that the insertion gap (G) is formed between the C-shaped retaining ring 3 and the inner peripheral surface 11 of the base member 1. The insertion end portion 51 of the second tool 5 can be inserted into the insertion gap (G) to pry out the C-shaped retaining ring 3 from the annular retaining groove 111 so as to facilitate removal of the C-shaped retaining ring 3 from the base member 1. Hence, the dismantling method of this disclosure is simple and convenient, and will not destroy the base member 1 and the insert member 2. Therefore, the object of this disclosure can indeed be achieved.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An inner C-shaped retaining ring assembly comprising:
a base member including an inner peripheral surface and an outer peripheral surface opposite to each other, said inner peripheral surface defining a receiving space that has a top opening, and having an annular retaining groove that communicates with said receiving space, said outer peripheral surface having at least one aperture that extends through said inner peripheral surface and that communicates with said annular retaining groove;
an insert member movably connected to said base member and having at least a portion received in said receiving space; and
a C-shaped retaining ring elastically disposed in said annular retaining groove to prevent removal of said insert member from said receiving space, said C-shaped retaining ring having two free ends, and a gap between said free ends, said C-shaped retaining ring blocking at least a portion of said at least one aperture;
wherein said gap does not overlap said aperture, and said C-shaped retaining ring is configured to be acted upon by an external force through said at least one aperture to elastically deform toward said receiving space and form an insertion gap with said inner peripheral surface of said base member, said insertion gap being configured for insertion of a tool to facilitate removal of said C-shaped retaining ring from said annular retaining groove.

2. The inner C-shaped retaining ring assembly as claimed in claim 1, wherein said at least one aperture is a threaded hole.

3. The inner C-shaped retaining ring assembly as claimed in claim 1, wherein said insert member includes a head portion movably received in said receiving space, and a socket portion extending upwardly from said head portion, said head portion being blocked by said C-shaped retaining ring and being limited in said receiving space, said base member further including a spring support disposed in said receiving space, said inner C-shaped retaining ring assembly further comprising an elastic member disposed in said receiving space between said head portion and said spring support.
